(19) United States
(12) Patent Application Publication
(10) Pub. No.: US 2006/0008253 A1
(43) Pub. Date: Jan. 12, 2006

(54) Data structure, recording medium, information reproducing apparatus, and information reproducing method

(76) Inventors: Kazutoshi Horiguchi, Ome-shi (JP); Takero Kobayashi, Akishima-shi (JP); Yasufumi Tsumagari, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/174,535

(22) Filed: Jul. 6, 2005

(30) Foreign Application Priority Data
Jul. 12, 2004 (JP) 2004-204817

(51) Int. Cl. H04N 5/781

(52) U.S. Cl. 386/96; 386/125

(57) ABSTRACT

A data structure configures picture information in accordance with a predetermined format and is decoded and reproduced by an information reproducing apparatus. The data structure comprises a plurality of picture information on a predetermined unit by unit basis, the information being read and decoded by the information reproducing apparatus, and being reproduced to be a reproduction signal for displaying a picture together with a voice, and a plurality of application information read and executed by the information reproducing apparatus, whereby predetermined images are reproduced to be a reproduction signal superimposed and displayed on the reproduced picture and the reproduced images are configured to be inserted among a plurality of picture and voice information on the predetermined unit by unit basis.

### CROSS-REFERENCE TO RELATED APPLICATIONS

This application is based upon and claims the benefit of priority from prior Japanese Patent Application No. 2004-204817, filed Jul. 12, 2004, the entire contents of which are incorporated herein by reference.

### BACKGROUND OF THE INVENTION

1. Field of the Invention

The present invention relates to a data structure on a recording medium which is reproduced by, for example, a digital versatile disk (DVD) reproducing apparatus or the like. More particularly, the present invention relates to: a data structure in which application information is multiplexed on essential picture information so as not to preclude a reproducing process; a recording medium which stores the data; and an information reproducing apparatus and an information reproducing method for reproducing the stored data.

2. Description of the Related Art

Recently, with improvement of a mobile image compression and signal processing technique, a picture information reproducing apparatus represented by DVD players has been widely prevalent. These conventional DVD players take the primary importance on reproduction of picture information which serves as main contents, and do not take importance on an additional function of presenting a user with accessory information very much. However, a function of interlocking picture information with an additional function to display, for example, information associated with one or more characters appearing on a screen greatly contributes to the user's convenience.

Patent document 1 (Jpn. Pat. Appln. KOKAI Publication No. 11-161663) discloses a technique of storing URL or the like in a navigation pack of a video object unit and operating a button or the like on a reproduced screen, thereby making it possible to display the associated Internet information.

In the above-described prior art, URL is stored in the navigation pack or the like which is control information provided to reproduce the main contents, and utilizing this URL to expand the associated information on the screen via the Internet. However, the information provided via the Internet is not always stable, and there is a problem that providing the optimal contents is not guaranteed. In addition, there is a problem that, even if an attempt is made to store picture information in the navigation pack or the like, the navigation pack has an effect on an essential reproduction control function, thus making it impossible to impart a sufficient additional function.

Therefore, a method of storing proper application information such as a still image or a mobile image in advance in a disk is conceived. For example, there can be conceived a case of storing the application information in a region that follows a region in which all essential title picture information are recorded has terminated. In this case, however, when the user instructs display of additional information from the screen, an access to title picture information during reproduction and an access to a region of application information which is distant from the title picture information are alternately provided. Thus, a pickup movement quantity and a movement delay increase, and an access to both of the regions cannot be smoothly provided, which results in a problem that there is a case in which a failure such as temporarily stopping reproduction of the essential title mobile image occurs.

### BRIEF SUMMARY OF THE INVENTION

A data structure according to an embodiment of the present invention is a data structure which configures picture information in accordance with a predetermined format and which is decoded and reproduced by an information reproducing apparatus, the data structure comprising: a plurality of picture and voice information on a predetermined unit by unit basis, the information being read and decoded by the information reproducing apparatus, and being reproduced to be a reproduction signal for displaying a picture together with a voice; and a plurality of application information read and executed by the information reproducing apparatus, whereby predetermined images are reproduced to be a reproduction signal superimposed and displayed on the reproduced picture and the reproduced images are configured to be inserted among the plurality of picture and voice information on the predetermined unit by unit basis.

A recording medium according to an embodiment of the present invention is a recording medium for storing in a recording region a data structure which configures picture information in accordance with a predetermined format and which is decoded and reproduced by an information reproducing apparatus, the data structure comprising: a plurality of picture information on a predetermined unit by unit basis, the information being read and decoded by the information reproducing apparatus, and being reproduced to be a reproduction signal for displaying a picture together with a voice; and a plurality of application information read and executed by the information reproducing apparatus, whereby predetermined images are reproduced to be a reproduction signal superimposed and displayed on the reproduced picture and the reproduced images are configured to be inserted among the plurality of picture and voice information on the predetermined unit by unit basis.

An information reproducing apparatus according to an embodiment of the present invention is an information reproducing apparatus comprising: a readout section configured to read out a recording medium which stores in storage regions thereof the plurality of picture voice information on a predetermined unit by unit basis configured in accordance with a predetermined format and a plurality of application information inserted among the plurality of picture voice information, respectively; a demultiplexer section configured to demultiplex the plurality of picture voice information read out by the readout section and the application information from each other; a memory section configured to expand the plurality of picture and voice information demultiplexed by the demultiplexer section to a first storage region and to expand the application information to a second storage region; a control section configured to make control so as to encode the plurality of picture and voice information expanded to the first storage region of the memory section, and to output a reproduction signal for displaying a picture together with a voice; and a processing section configured to, in response to an instruction, output a reproduction signal for superimposing and displaying an image according to the application information expanded to the second storage region without intermitting a picture being reproduced by the control section.

### BRIEF DESCRIPTION OF THE SEVERAL VIEWS OF THE DRAWING

FIG. 1 is a conceptual view showing an example of a data structure according to one embodiment of the present invention;

FIG. 2 is an illustrative view illustrating an example of the data structure according to one embodiment of the invention to be associated with an optical disk;

FIG. 3 is an illustrative view illustrating an example in which application information is multiplexed in units of VOBUs, in the data structure according to one embodiment of the invention;

FIG. 4 is an illustrative view illustrating an example in which application information is multiplexed in units of packs, in the data structure according to one embodiment of the invention;

FIG. 5 is a block diagram depicting an example of a configuration of a recording and reproducing apparatus according to one embodiment of the invention;

FIG. 6 is an illustrative view illustrating an example in the case where application information is expanded to a buffer in the recording and reproducing apparatus according to one embodiment of the invention;

FIG. 7 is a flow chart showing an example of a process of multiplexing application information in the recording and reproducing apparatus according to one embodiment of the invention;

FIG. 8 is a flow chart showing an example of a process of reproducing application information in the recording and reproducing apparatus according to one embodiment of the invention;

FIG. 9 is an illustrative view illustrating an example in the case of reproducing application information in accordance with another method; and

FIG. 10 is an illustrative view illustrating an example in the case where application information is reproduced at the same time as when picture information is reproduced in the recording and reproducing apparatus according to one embodiment of the invention.

### DETAILED DESCRIPTION OF THE INVENTION

Hereinafter, preferred embodiments of the present invention will be described with reference to the accompanying drawings.

<Data Structure According to One Embodiment of the Invention>

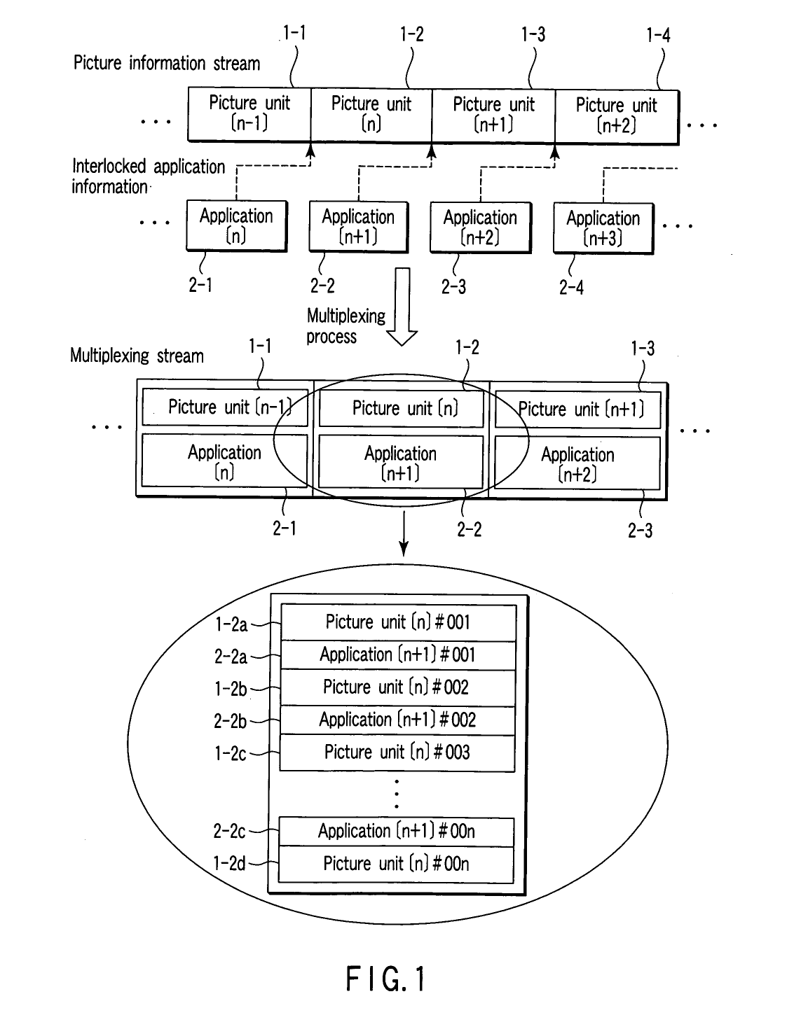

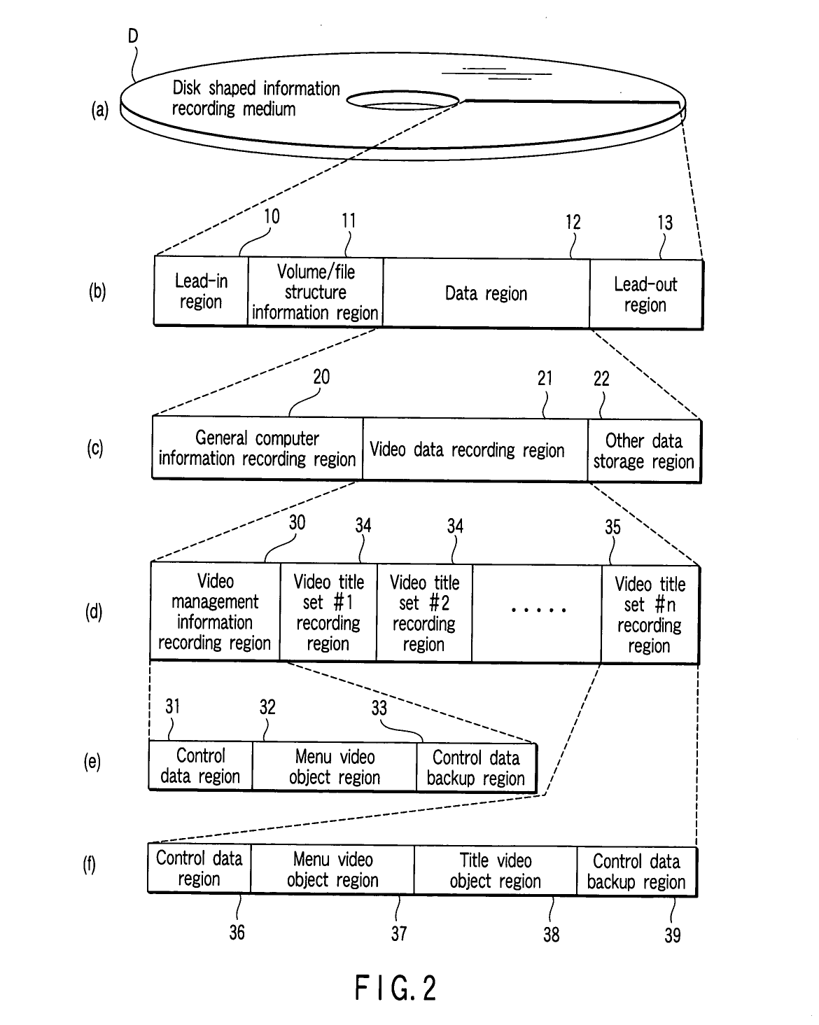

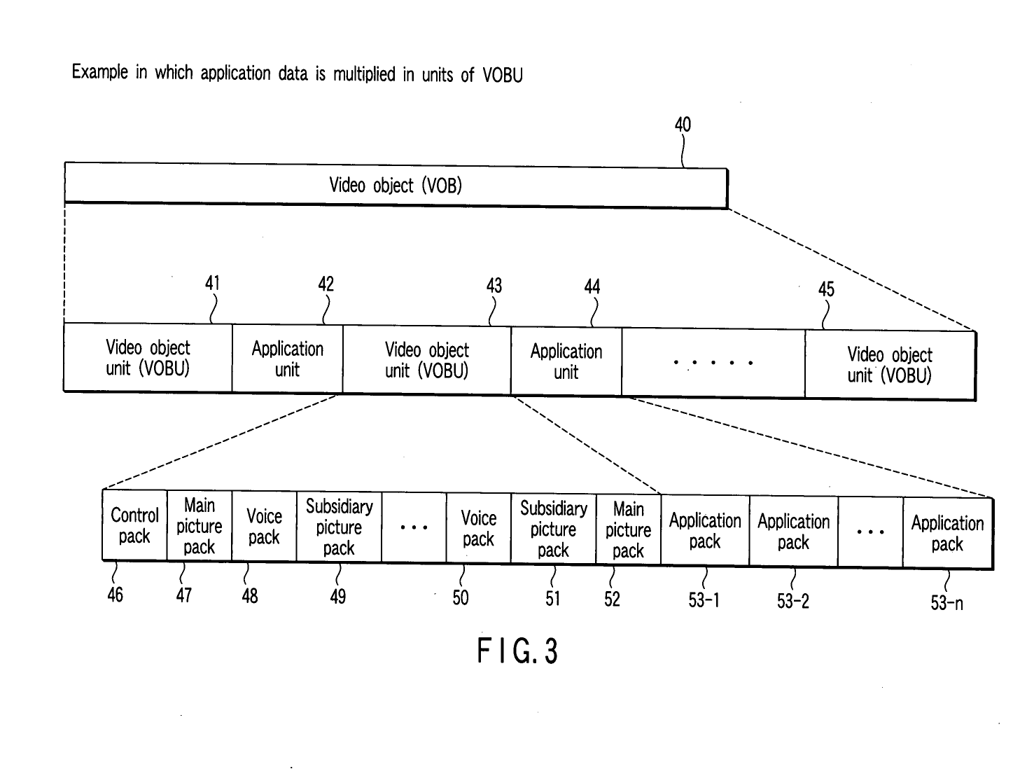

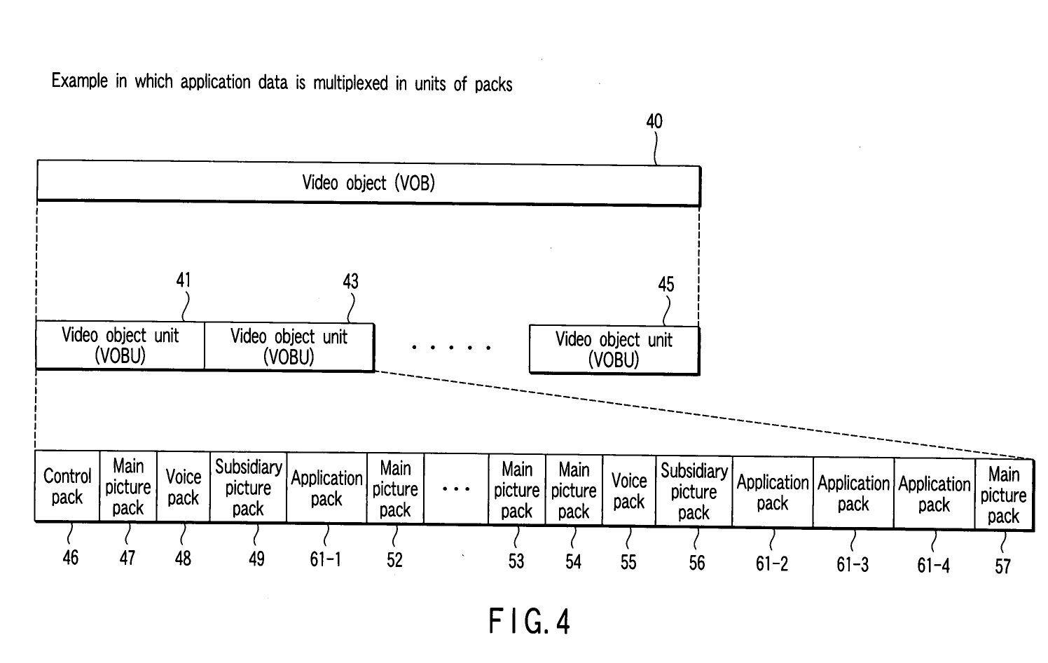

FIG. 1 is a conceptual view showing an example of a data structure according to one embodiment of the invention; FIG. 2 is an illustrative view illustrating an example of the data structure according to one embodiment of the invention to be associated with an optical disk; FIG. 3 is an illustrative view illustrating an example in which application information is multiplexed in units of VOBUs, in the data structure according to one embodiment of the invention; and FIG. 4 is an illustrative view illustrating an example in which application information is multiplexed in units of packs, in the data structure according to one embodiment of the invention.

(Concept of Data Structure)

The data structure according to one embodiment of the invention is stored in, for example, a storage region of a DVD. As shown in the conceptual view of FIG. 1, picture information, each item of which is a unit of reproduction, is allocated inside of the data stored in a DVD or the like, and these items of the information are continuously reproduced in order, whereby a mobile image can be visualized.

The unit of reproduction is expressed as a picture unit [n] in the conceptual view of FIG. 1. In addition, application information interlocked with reproduction start of these picture units [n] is expressed like application [n]. Here, “n” is a parameter indicating a time series and is a value which increases as reproduction advances.

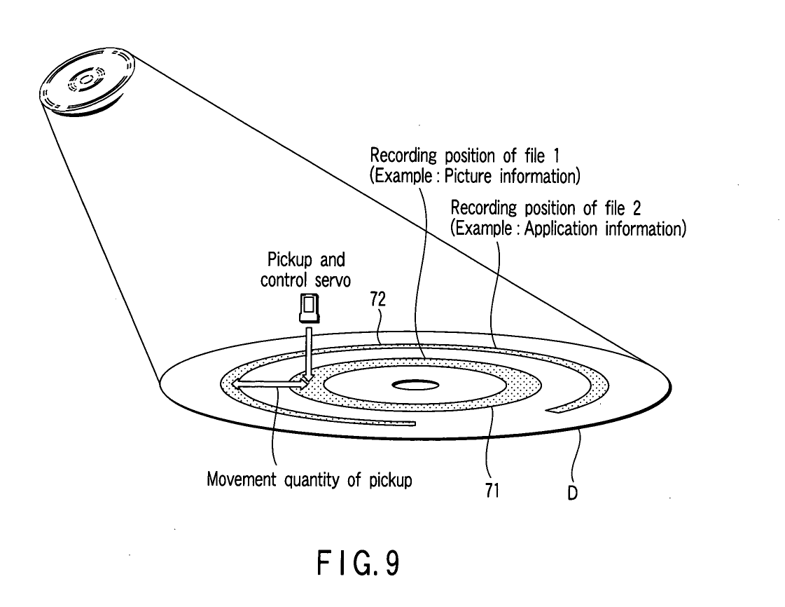

Here, let us consider a case in which picture information and application information are maintained as a plurality of files 71, 72 on a recording medium, for example, as shown in FIG. 9. As described above, while an access is provided to a file 1 (71) in order to reproduce picture information, an access must be provided to a file 2 (72) at the same time in order to move a pickup and execute the application information. Thus, there is a danger that the essential title picture information cannot be smoothly read, and reproduction of the picture information becomes slow.

Therefore, in order to cope with this failure, the present embodiment proposes a data multiplexing method for handling application information as one item of data. FIG. 1 shows an example of a data structure multiplexed in accordance with this multiplexing method.

A multiplexing process is carried out for each of picture units 1-1 to 1-4, as shown in FIG. 1, and data targeted for multiplexing are picture units [n] 1-1 to 1-4 and application [n+1] 2-1 to 2-4.

Here, it should be noted that, in FIG. 1, the time series of application information precedes picture information by one item during multiplexing in a relationship between the time series of the picture information and the time series of the application information. This is because there is a need for a CPU to enable execution of application [n+1] (=All the data have been acquired) by a reproduction start time of the picture unit [n+1].

In addition, this is because application [n+1] is executed at an arbitrary timing from a reproduction start time of the picture unit [n+1] to a reproduction start time of a picture unit [n+2], thus making it necessary to complete acquisition of all the data of the application [n+1] earlier than the reproduction start time. Thus, the application [n+1] is multiplexed in units of reproduction earlier than the picture unit [n+1].

Further, during multiplexing, the picture unit [n] and the application [n+1] are multiplexed to be divided. The divided size is multiplexed so as not to cancel reproduction of the picture unit [n] during reproduction, namely, so as to ensure that no underflow or overflow occurs in a buffer of an MPEG decoder. Specifically, a capacity of application information is calculated by a multiplexer section 128 or the like of an information recording apparatus described later to an extent such that a read speed required by picture voice information and application information which are title picture information does not reach a read speed of the recording medium, for example, a reproduction speed equal to or higher than 10.08 Mbps. Based on this capacity, application information is inserted between the picture units (such as a plurality of picture voice information=control information, picture information, and voice information).

As a result of the above multiplexing process, a multiplexing stream is generated such that picture unit [n] 1-2 and application [n+1] 2-2 interlocked with picture unit [n+1] to be reproduced next are multiplexed with each other, as shown in FIG. 1. At this time, it is also preferable that, with respect to the picture information and the application information, picture units [n] #001 to #00n (1-2a to 2d) and applications [n+1] #001 to #00n (2-2a to 2d) are alternately allocated in units of information, as an example in the form that, as an example, the application [n+1] #001 (2-2a) is inserted between the picture unit [n] #001 (1-2a) and the picture unit [n] #002 (1-2b).

The above-described multiplexing stream having the data structure is stored as one file in a recording medium, and is reproduced from the recording medium, so that a control section of the information and reproducing apparatus can provide both of the essential title picture information and additional application information by reading data from one continuous disk, making it possible to smoothly reproduce both of these information.

<Data Structure: VOBU Unit>

A specific example of a data structure according to one embodiment of the invention will be shown below. In (a) of FIG. 2, there is shown an external view of a disk shaped information storage medium D in which an example of the above-described data structure is achieved. The information storage medium D has a lead-in region 10, a volume/file structure information region 11, a data region 12, and a lead-out region 13 in order from its inner periphery side, as shown in (b) of FIG. 1.

Among them, the data region 12 is composed of a general computer information recording region 20, a video data recording region 21, and another data recording region 22, as shown in (c) of FIG. 1.

The video data recording region 21 has: a video management information recording region 30 for managing all the information recorded in the information storage medium D; and one or more video title set #n recording regions 34 for managing information on a title by title basis, as shown in (d) of FIG. 1.

As shown in (e) of FIG. 1, the video management information recording region 30 is composed of a control data (HD_VMG.IFO file) region 31, a menu video object (HD_VMGM.VOB file) region 32, and a control data backup (HD_VMG.BUP file) region 33.

Further, the above-described video title set #n recording region 34 has a control data (HD_VTS.IFO file) region 36, a menu video object (HD_VTSM.VOB file) region 37, a title video object (HD_VTS.VOB file) region 38, and a control data backup (HD_VTS.BUP file) region 39, as shown in (f) of FIG. 1.

Here, FIGS. 2 and 3 each show one or more video objects (VOB) 40 stored in each of the video object regions 32, 37, and 38 described above.

The video object 40 is composed of one or more video object units (VOBU) 41, as shown in FIGS. 2 and 3. The video object unit 41 may be defined as a minimum unit of reproduction as an example, but not limited thereto.

The video object unit 43 is composed of a head control pack 46, a plurality of main picture packs 47, 52, selectable first and second voice packs 48, 50, and selectable first and second subsidiary picture packs 49, 51, as shown in FIGS. 2 and 3. The selected first or second voice pack 48, 50 and the selected first or second subsidiary picture pack 49, 51 are synchronously reproduced together with the main picture pack 47 in the video object unit 43.

With respect to such video object units 41, 43, application packs 53-1, 53-2, . . . , 53-n are allocated outside of the video object units 41, 43 without allocating an application pack inside of the video object units 41, 43. That is, application units 42, 44 are allocated to be inserted between the video object units 41 and 43. The application units 42, 44 each have a plurality of application packs 53-1, 53-2, . . . , 53-n.

In this way, each pack is synchronously reproduced in the video object unit 41. Thus, the application units are allocated outside of the video object units, thereby making it possible to ensure operating stability.

However, there is always no need for providing such a mode. It is preferable that an application pack be allocated to be inserted between the picture packs or the like, as shown below.

(Data Structure: Pack Unit)

A data structure according to another embodiment of the present invention allocates each application pack in each picture pack in units of pack, as shown in FIG. 4. That is, in FIG. 4, the video object 40 has a plurality of video object units 41 to 45. Further, each of the video object units 41 to 45 has a plurality of control packs 46, a main picture pack 47, a voice pack 48, and a subsidiary picture pack 49 or the like. It is preferable that an application pack 61-1 is properly allocated to be inserted between them.

At this time, if a large amount of application pack is inserted, reproduction of the essential main picture pack is precluded. Thus, a capacity is calculated to an extent such that the read speed required by the picture voice information which is title picture information, a control pack, a picture pack, and a voice pack etc. does not reach a read speed of the recording medium, for example, a reproduction speed equal to or higher than 10.08 Mbps, and application information is allocated in the range of that capacity. It is preferable that this capacity calculation or the like is carried out by a multiplexer section 128 or the like of an information recording apparatus described later without being limited thereto.

At this time, with respect to the main picture pack or the like, it is preferable that, for example, the size of an application pack is equal to or smaller than 2048 bytes such as a main picture pack, for example, is half of 2048 bytes, in order to provide optimal application information. In addition, it is also preferable to optimally adjust the capacity of application information in accordance with the number of continuous application packs.

<Recording and Reproducing Apparatus According to One Embodiment of the Invention>

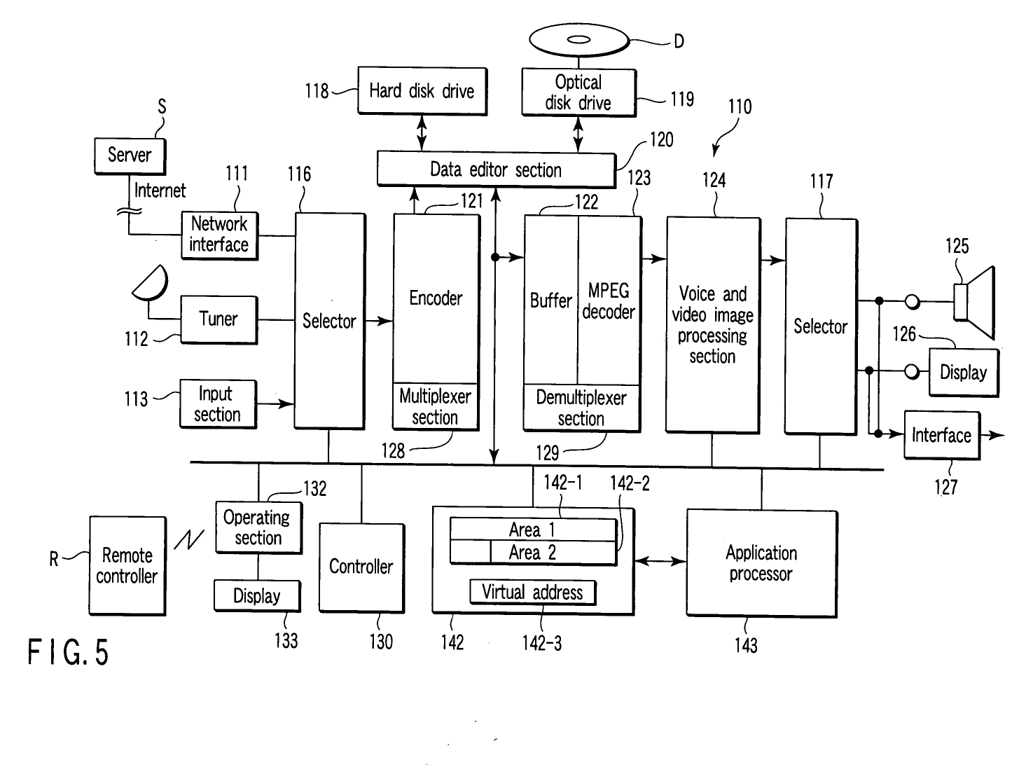

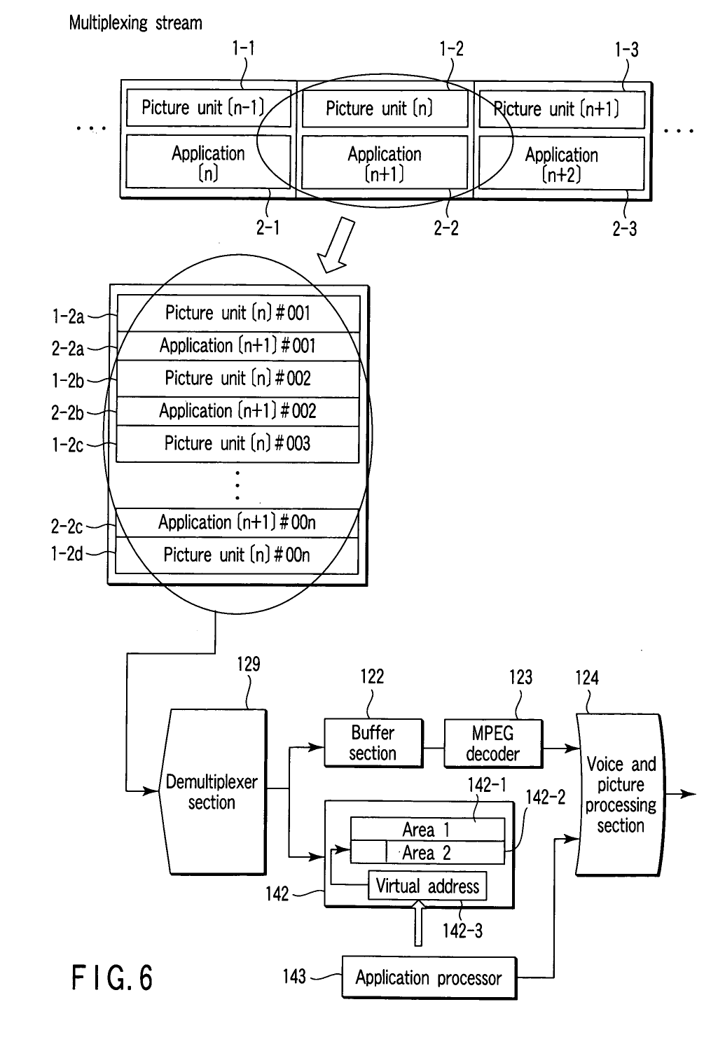

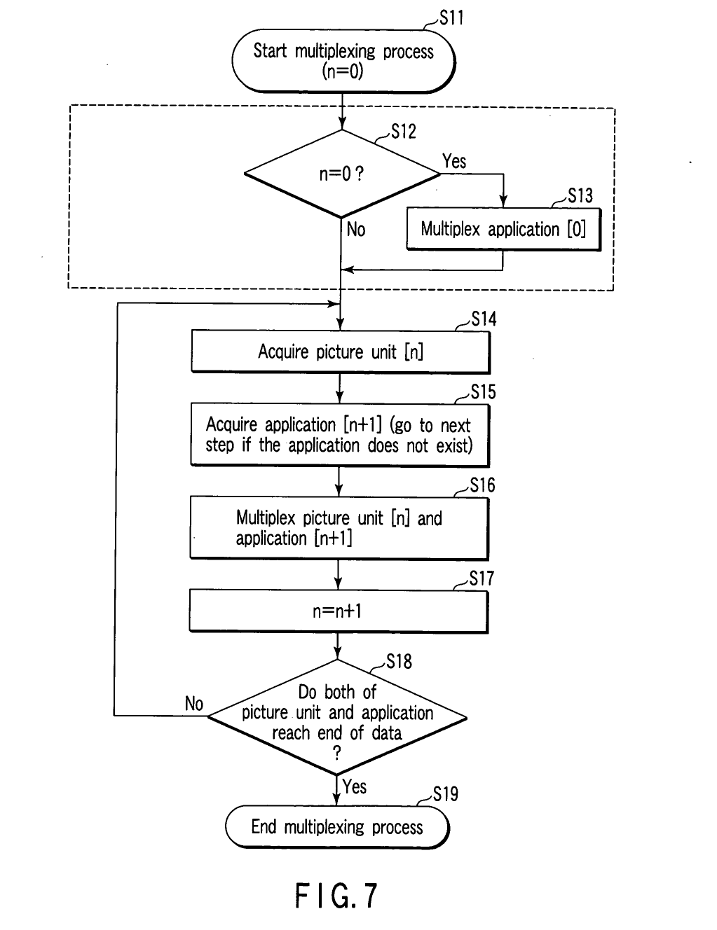

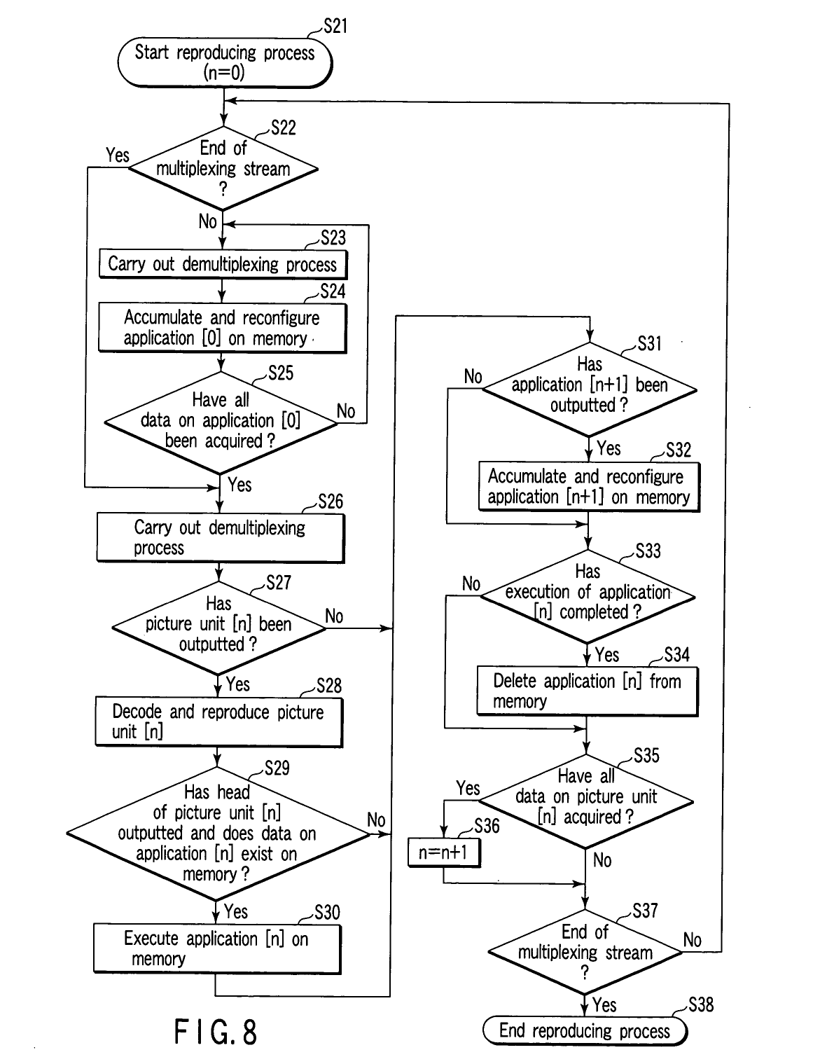

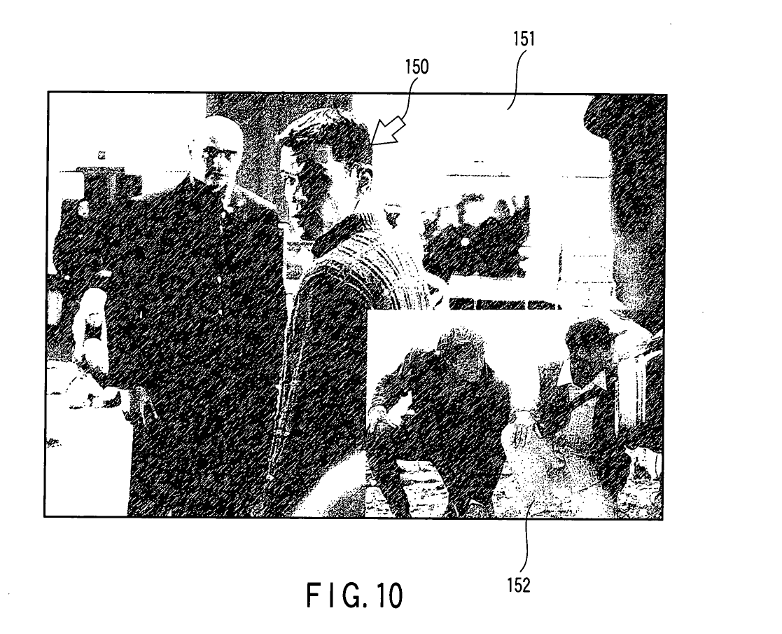

Now, with reference to the accompanying drawings, a detailed description will be given below with respect to an example of a recording and reproducing apparatus for generating (multiplexing) data having the above-described data structure, carrying out a recording process for, for example, a DVD, or alternatively, carrying out a reproducing process (de-multiplexing process) between a main picture and application information with respect to recording information having such a data structure. FIG. 5 is a block diagram depicting an example of a configuration of a recording and reproducing apparatus according to one embodiment of the invention; FIG. 6 is an illustrative view illustrating an example in the case where application information is expanded to a buffer in the recording and reproducing apparatus according to one embodiment of the invention; FIG. 7 is a flow chart showing an example of a process of multiplexing application information in the recording and reproducing apparatus according to one embodiment of the invention; FIG. 8 is a flow chart showing an example of a process of reproducing application information in the recording and reproducing apparatus according to one embodiment of the invention; FIG. 9 is an illustrative view illustrating an example in the case of reproducing application information in accordance with another method; and FIG. 10 is an illustrative view illustrating an example in the case where application information is reproduced at the same time as when picture information is reproduced in the recording and reproducing apparatus according to one embodiment of the invention.

(Configuration)

While the embodiment introduces a recording and reproducing apparatus as an apparatus capable of handling both of a DVD-RAM and a hard disk which serve as recording media, it is preferable that, for example, a recording medium using a semiconductor memory or the like is included without being limited thereto. The blocks shown in FIG. 5 are roughly divided as follows. A main block of a recording section is shown at the left side, and a main block of a reproducing section is shown at the right side.

The recording and reproducing apparatus shown in FIG. 5 has two types of disk drive sections. First, the recording and reproducing apparatus has an optical disk drive section 119 which rotationally drives an optical disk D as a first medium which is an information recording medium capable of constructing a video file and reads and writes information. In addition, the apparatus has a hard disk drive section 118 which drives a hard disk as a second medium. The control section 130 is connected to each section via a data bus in order to control a whole operation.

The recording and reproducing apparatus shown in FIG. 5 is essentially configured of an encoder section 121 which configures a recording side, an MPEG decoder section 123 which configures a reproduction side, and a control section 130 which controls an operation of the apparatus main body. The recording and reproducing apparatus has an input side selector 116 and an output side selector 117. A network interface (I/F) section 111, a tuner section 112, and an input section 113 are connected to the input side selector 116, and a signal is outputted to the encoder section 121. The recording and reproducing apparatus also has: the encoder section 121; a data editor section 120 which carries out desired data processing such as data editing upon the receipt of an output of the encoder section 121; the hard disk drive section 118 connected to the data editor section 120; and the optical disk drive section 119. The recording and reproducing apparatus further has: an MPEG decoder section 123 which receives and decodes a signal from the hard disk drive section or the optical disk drive section 119; the encoder section 121; a buffer section 122; the MPEG decoder section 123; the multiplexer section 128; the demultiplexer section 129; the control section 130; a memory section 142; and an application processing section 143. These sections each are connected to the control section 130 via a data bus. Further, an output of the selector section 117 is connected to an external speaker section 125 and a display section 126 or is supplied to an external device via an interface section 127 which makes communication with an external device.

In addition, the memory section 142 has a first area 142-1, a second area 142-2, and a virtual address section 142-3.

Further, the recording and reproducing apparatus has an operating section 132 connected to the control section 130 via a data bus, the control section receiving an operation of a user operation or an operation of a remote controller R. The remote controller used here enables operations which are substantially equal to those of the operating section 132 provided in the main body of the recording and reproducing apparatus. The remote controller can provide a variety of settings such as a recording and reproducing instruction for the hard disk drive section 118 or the optical disk drive section 119, an editing instruction, a tuner operation, and setting of reservation recording.

(Operation)

Basic Operation

Now, a general description of a reproducing process and a recording process will be given by way of example of an optical disk in a recording and reproducing apparatus having such a configuration. Under the control of the control section 130, a laser light beam is emitted on the optical disk D rotated at a predetermined speed, its reflection light is detected by an optical pickup, and a detection signal S is outputted based on the detection. An RF signal is generated based on this detection signal S, and a reproducing process that follows a data reading process is carried out.

In a process of recording an optical disk, for example, the data supplied via the input section 13 and the selector 116 is supplied to the encoder section 121, and the supplied data is encoded and outputted, under the control of the control section 130. In response to this encoded output and an output of the control section 130, the drive current of a laser driver 165 is supplied to an optical pickup 151, and light is emitted to a storage region of the optical disk D, whereby the recording process is carried out.

Recording Process or the Like

Now, an operation of the recording and reproducing apparatus having such a configuration will be described in more detail. First, a recording operation will be primarily described in detail including that in another embodiment. As an input side of the recording and reproducing apparatus, the network I/F section 111, for example, is connected to a server S or the like via the Internet, and downloads contents information etc. In addition, the tuner section 112 selects and demodulates a broadcast signal via an antenna and inputs a picture signal and a voice signal. The tuner section supports various types of broadcast signals, for example, covers a terrestrial wave analog broadcast, a terrestrial wave digital broadcast, a BS analog broadcast, a BS digital broadcast, and a CS digital broadcast without being limited thereto. Instead of providing only one tuner, it is also preferable that, for example, two or more tuner sections of the terrestrial wave analog broadcast are provided and caused to function in parallel in response to a request for reservation recording.

The input section 113 externally receives picture signals such as a luminance signal, a color difference signal or a composite signal, and a voice signal. These signals, inputs of which are controlled by the selector 116 controlled by the control section 130 or the like, are selectively supplied to the encoder section 121. That is, an external analog video signal and an external analog audio signal from the input section 113 or an analog video signal and an analog audio signal from the TV tuner 112 are inputted to the encoder section 121 via the selector 116.

The encoder section 121 includes video and audio analog digital converters which digitize the analog video signal and analog audio signal inputted by the selector 116; a video encoder; and an audio encoder. The encoder section also includes a subsidiary picture encoder. An output of the encoder section 121 is converted into a compression format such as predetermined MPEG, and the converted output is supplied to the control section 130 described previously.

Here, the apparatus shown in FIG. 5 can supply the information (packs such as video, audio, and subsidiary picture data) encoded by the encoder section 121 and the produced management information to the hard disk drive section 118 or the optical disk drive section 119 via the control section 130, and record these information in the hard disk drive section 118 or the optical disk D. The apparatus can also record the information recorded in the hard disk drive section 118 or the optical disk D in the optical disk D or the hard disk drive section 118 via the control section 130 or the optical disk drive section 119.

Editing Process or the Like

The data editor section 120 can carry out an editing process such as partially deleting video objects of a plurality of programs recorded in the hard disk drive section 118 or the optical disk D or connecting objects of different programs.

During the editing process or another process, the contents to be notified to a user from among the execution result of an MPU are displayed on a display section 133 of the recording and reproducing apparatus or an on-screen display (OSD) displayed on the display 126. In addition, the control section 130 has an operating section 132 which supplies an operating signal for operating the apparatus. It is preferable that the operating section 132 further has the remote controller R.

Reproducing Process or the Like

Now, a detailed description will be given with respect to a process of reproducing mainly recorded information including that in another embodiment. The MPEG decoder section 123 comprises a video processor which properly combines the subsidiary pictures decoded for the decoded main pictures and outputs a menu, a highlight button, a subtitle, or any other subsidiary picture to be superimposed on the main picture.

An output audio signal of the MPEG decoder section 123 is converted to an analog signal by a digital analog converter section (not shown) via the selector section 117. The analog converted signal is supplied to the speaker 125 or is supplied to an external device via the I/F section 127. The selector section 117 is controlled by a select signal from the control section 130. In this manner, the selector section 117 can directly select a signal through the encoder section 121 when a digital signal from the TV tuner 112 or the input section 113 is directly monitored.

The recording and reproducing apparatus according to the present embodiment has such a comprehensive function and carries out a recording and reproducing process for a plenty of sources by means of the optical disk D or the hard disk drive section 118. A detailed description will be given below with respect to a multiplexing process and a demultiplexing process (reproducing process) of the recording and reproducing apparatus.

<Application Information Multiplexing Process>

Now, an example of a multiplexing process according to one embodiment of the invention will be described below with reference to a flow chart shown in FIG. 7. The multiplexing process used here denotes multiplexing essential main picture information and additional application information, generating the above-described data structure, and further, recording the data structure in, for example, a DVD-RAM (or DVD-ROM) or recording the data structure in another recording medium such as the hard disk drive section 118.

In the above-described recording and reproducing apparatus, first, streams 1-1 to 1-3 of the main picture information shown in FIG. 6, and streams 2-1 to 2-3 of application information are acquired in accordance with user operation information or the control of the control section 130 by means of the encoder section 121 and the multiplexer section 128 via the input section 113, the tuner section 112, and the network L/F section 111 etc. or via the selector section 116. These streams of information may be stored in the hard disk drive 118. Then, the streams of the main picture information is properly converted to a recordable signal mode such as a control pack, a picture pack, or a subsidiary picture pack by means of the encoder section 121. Next, a multiplexing process is started in accordance with an operating progress for the multiplexing process incorporated in the control section 130 and the multiplexer section 128, and a time series parameter “n” of each stream is set to 0 (S1). Then, it is determined whether or not a current state is established immediately after starting the multiplexing process (S12). If the determination result is affirmative, multiplexing of application [0] is carried out (S13).

Further, in the multiplexing process that follows n =1, a picture unit [n] targeted for the multiplexing process is acquired (S14). Next, application [n+1] is acquired (S15). At this time, if application [n+1] does not exist, namely, if there is no need for executing any application at the time of starting reproduction of the picture unit [n+1], acquisition of application is not carried out.

With respect to a difference in time series between picture information and application information, it is preferable that the application information precedes the picture information. However, it is not necessarily required to establish such a time series relationship, and it is possible to execute processing even in the simultaneous time series. It is also preferable to provide a difference in time series such as “5” or “10”.

Next, multiplexing is carried out for the thus acquired picture unit [n] and application [n+1] (S16). Here, as described above, the picture unit [n] and application [n+1] are multiplexed to be divided during multiplexing. The divided size is multiplexed so as not to cancel reproduction of the picture unit [n] during reproduction, namely, so as to ensure that no underflow or overflow occurs in a buffer of the MPEG decoder. Specifically, a capacity of application information is calculated by the multiplexer section 128 or the like of the information recording apparatus described later to an extent such that a read speed required by picture voice information and application information which are title picture information does not reach a read speed of the recording medium, for example, a reproduction speed equal to or higher than 10.08 Mbps. Based on this capacity, application information is inserted between the picture units (such as a plurality of picture voice information=control information, picture information, and voice information).

A variety of modes of inserting application information into the picture unit (such as a plurality of picture voice information=control information, picture information, and voice information) are available. For example, the above-described cases of VOBU units and pack units are available.

Next, multiplexing between the picture unit [n] and the application [n+1] is terminated, a time series parameter “n” is added, and processing of the next picture information is advanced (S17). This multiplexing process is carried out until data end of each item of information has been reached (S18). When multiplexing between all the main picture streams and the application stream terminates, the multiplexing process is terminated (S19). The data stream having the multiplexed data structure shown in FIG. 3 or 4 is recorded in a recording region of the storage medium D such as, for example, a DVD via the optical disk drive section 119. However, it is preferable that a recording process is carried out relevant to a recording medium in parallel while advancing the multiplexing process. In this way, the application information multiplexing process according to one embodiment of the invention is carried out, thereby making it possible to reliably carry out reproduction of the main video information and reproduction of the application information described below.

While the present embodiment has described the multiplexing process as, for example, a recording process of the DVD recording and reproducing apparatus, the multiplexing can be carried out similarly in an authoring system for manufacturing a DVD-ROM having a structure which is substantially identical to the DVD recording and reproducing apparatus.

<Reproducing Process Using Application Information Demultiplexing Process>

Now, a reproducing process using a demultiplexing process for reproducing a recording medium which has the thus multiplexed data structure will be described below in detail with reference to an illustrative view of FIG. 6 and a flow chart of FIG. 8.

First, a general description of a reproducing process using the application information demultiplexing process will be described here. The above-described recording and reproducing apparatus presumes a state in which the multiplexing stream generated by the multiplexing process is stored in a storage medium D such as a DVD. The multiplexing stream read out from the optical disk drive 119 cannot be inputted to and reproduced at the MPEG decoder section 123 as is, and thus, the stream is first inputted to the demultiplexer section 129. The multiplexer section 129 used here is a demultiplexing processing section and has a demultiplexer structure as an example.

The demultiplexer (demultiplexing processing section) 129 serially outputs the items of picture unit [n] and the application [n+1] divided by the demultiplexing process to the inputted multiplexing stream. These divided picture units [n] are demultiplexed, respectively, and are temporarily stored in the memory section 142 used for a decoder. The temporarily stored picture units are inputted to the MPEG decoder section 123 via the buffer section 122 in response to advancement of mobile image reproduction. The fact that the buffer section 122 does not cause an underflow or an overflow is guaranteed by calculation and control when the multiple stream of the above-described multiplexer section 128 is generated.

The MPEG decoder section 123 decodes the inputted picture information and supplies a voice and mobile image signal to the voice and picture processing section 124, whereby picture information is reproduced.

On the other hand, the divided and outputted application information [n+1] is stored and reconfigured in a file system of the memory section 142 such as a RAM disk. With respect to this application information [n+1], the fact that all the relevant data are allocated at a position which precedes a position at which the picture unit [n+1] contained in the multiplexing unit is generated is ensured by the multiplexing process described below.

Thus, by a time point when reproduction of the picture unit [n+1], the application [n+1] are allocated on the memory section 142 in the reconfiguration complete or executable state. Therefore, similarly, by a time point when reproduction of the picture unit [n] is started, the corresponding application information [n] is established in a storage or reconfiguration complete state on the file system of the memory section 142.

The application processing section 143 executes an application with reference to the application information [n] allocated on the memory section 142 at the same time as reproduction of the picture unit [n], in response to the user's operating instruction or the like, and supplies the generated voice and screen image to the voice and picture processing section 124. In addition, at the same time as when the application terminates, the application processing section 143 deletes unnecessary application information from the memory section 142.

In this manner, for example, when the user specifies an actor's region on a picture screen 151 from a cursor or the like of the remote controller R by a pointer 150 or the like as shown in FIG. 10, the picture information associated with the actor is displayed as application information on a superimposed screen 152 located at the lower left corner etc. of the picture screen 151. Here, for example, the latest cinema's highlight picture of an actor in main role is reproduced.

Here, storage areas 142-1 and 142-2 for two maximum sizes of application information are allocated on the memory section 142. In the case where executable data is maintained in one area, the other area is utilized for storage or reconstruction. In this manner, even if rewriting cannot be carried out in one area while an application is executed, application information can be stored or reconfigured in the other area.

Further, a certain virtual address 142-2 is provided, and the application processing section 143 always executes an application from this virtual address and switches this virtual address so as to specify an executable application information area, thereby making it possible to quickly and simply switch the location of application information.

For example, in the case where a discontinuous reproducing process such as skip reproduction has occurred, there is a high possibility that application information interlocking with picture information immediately after skipped does not exist on the memory section 142. Even in such a case, the above virtual address is switched so as to directly specify the application information allocated on a recording medium, thereby making it possible to cope with this situation.

The voice and picture processing section 124 combines the picture data obtained by decoding the delivered MPEF data with the picture data generated by executing the application and outputs a mobile image signal to a display device, whereby the reproducing process using the application information demultiplexing process according to one embodiment of the present invention completes.

Now, the above-described reproducing process using the application information demultiplexing process will be described with reference to a flow chart of FIG. 9. In the recording and reproducing apparatus, for example, reproduction of the stream information read out by the optical disk drive section 119 is started when time series parameter n=0 (S21), and it is determined whether or not the read-out stream information is at the head of the multiplexing stream (S22). When the determination result is affirmative, processing goes to S23. Otherwise, processing goes to S26.

In the case where the information is at the head of the multiplexing stream, the demultiplexing process is carried out for the multiplexing stream by using the above-described memory section 142 or the like (S23) and application [0] to be outputted is stored and reconstructed on the memory section 142 (S24). This process is carried out for all the data relevant to the application [0].

When these processes terminate, the demultiplexing process is advanced (S26) and it is determined whether or not the picture unit [n] contained in the read-out stream information is outputted (S27). In the case where the picture unit [n] is outputted, processes of decoding and reproducing the outputted picture unit [n] are carried out (S28). Then, it is determined that the picture unit [n] outputted by demultiplexing includes the head of the picture information and whether or not the application [n] reconfigured on the memory section 142 exists (S29). In the case where it exists, the application is executed (S30).

In the case where the application [n] does not exist, it is determined whether or not an output of the demultiplexing process is an application [n+1] (S31). In the case where the application [n+1] is outputted, the application information [n+1] is stored and reconfigured on the memory section 142 (S32). Otherwise, the application information [n+1] is stored and reconfigured on the memory (S32).

Then, it is determined whether or not execution of the application [n] has executed (S33). In the case where the execution has completed, there is no need for data on the application [n], and thus, the data is deleted from the memory section 142 (S34).

Then, it is determined whether or not all the data relevant to the picture unit [n] has been acquired by the demultiplexing process described previously (S35). In the case where the determination result is affirmative, processing is advanced so as to acquire the next picture unit [n+1] (S36). Otherwise, it is determined whether or not the end of the multiplexing stream has been reached in order to continue the above-described processing for the picture unit [n] (S37).

In the case where the end of the multiplexing stream has not been reached, the above processing is repeated. In the case where the end has been reached, the reproducing process is terminated (S38).

Here, by executing an application, for example, when the user specifies an actor's region on the picture screen 151 by the pointer 150 or the like from the cursor or the like of the remote controller R as shown in FIG. 10, the picture information associated with the actor is displayed as application information on the superimposed screen 152 located at the lower left corner or the like of the picture screen 151. In this manner, with respect to the main picture information stored in the buffer section 122, reproduction smoothly continued without an occurrence of an underflow or an overflow, and at the same time, an application can be executed according to the user's instruction.

The application used here assumes a variety of modes. As an example, there can be provided a navigation function having a variety of information such that the main picture information and the application function are interlocked with each other; that, when one of the characters appearing on the screen is selected, his or her profile or photography situation, explanation, advertisement, associated picture and the like are displayed to be interlocked with each other or an application such as a game or a browser is started up.

In particular, the main picture information and the application information can be reproduced in parallel with association of a time series by the multiplexing process according to one embodiment of the invention. This makes it possible to stably reproduce a comparatively large amount of application information. In addition, this easily makes it possible to smoothly reproduce another picture while reproducing the main picture, which has not been achievable conventionally.

During the multiplexing process described previously, it is preferable to provide additional information relating to application information such as a total number of divisions, serial numbers, data size, storage memory position, or expiration date on the basis of the first application division data or on the divisional data by data basis. By carrying out such packaging, it is possible to flexibly carry out processing such as determination of the storage position, file system capacity to be allocated, or the necessity of the reproducing process when application information is reconfigured by the demultiplexing process.

In addition, the reconfigured application information and the previously described additional information are managed altogether, thereby comparing the reproduction time of the currently reproduced picture information with the expiration date of application information. In the case where the current reproduction time is within the expiration date, reconfiguration and maintenance of the application information are continued. Otherwise, a data control process such as file system deletion is carried out. In this manner, for example, it is possible to efficiently use the same items of application information for picture information reproduction of a plurality of scenes or to manage unnecessary data so as not to be maintained on the file system for a long period of time.

As has been described above, according to one embodiment of the invention, there is provided a data structure, a recording medium, a reproducing apparatus, and a reproducing method for acquiring main picture information and application information in parallel and in a sequential manner and acquiring in advance the application information interlocked with the picture data when reproduction of the main picture is started, thereby making it possible to easily carry out a navigation process or the like based on a comparatively large amount of application information without precluding reproduction of the essential main picture.

That is, in the data structure according to one embodiment of the invention, the application information divided in plurality each are configured to be inserted among a control information pack, a picture information pack, and a voice information pack which are a plurality of picture and voice information to an extent such that reproduction of the essential title picture information is not precluded. In this manner, in, for example, a DVD reproducing apparatus, picture information for a predetermined time interval and application information corresponding to this predetermined time interval can be provided in a buffer, thus making it possible to execute processing using the application information which corresponds to the picture information being reproduced.

In this manner, in, for example, cinema reproduction, the character in main role on the screen is specified by operating a cursor or the like of a remote controller, thereby enabling processing such that a picture of a cinema on which a character in main role first appears is displayed at a corner of the screen. That is, the currently reproduced picture information and application information associated therewith can be continuously read out efficiently, and these information can be expanded, thus making it possible to stably provide a comparatively large amount of mobile image information relevant to the associated application.

Although one skilled in the art can achieve the present invention by the above-described various embodiments, a variety of modified examples of these embodiments can further be easily conceived by one skilled in the art. In addition, the present invention can be applied to a variety of embodiments even if one does not have an inventive ability. Therefore, the present invention covers a wide range as long as it does not conflict with a disclosed principle and novel features, and is not limited to the above-described embodiments.

What is claimed is:

1. A data structure which configures picture information in accordance with a predetermined format and which is decoded and reproduced by an information reproducing apparatus, the data structure comprising:
a plurality of picture and voice information on a predetermined unit by unit basis, the information being read and decoded by the information reproducing apparatus, and being reproduced to be a reproduction signal for displaying a picture together with a voice; and
a plurality of application information read and executed by the information reproducing apparatus, whereby predetermined images are reproduced to be a reproduction signal superimposed and displayed on the reproduced picture and the reproduced images are configured to be inserted among said plurality of picture and voice information on the predetermined unit by unit basis.

2. A data structure according to claim 1, wherein the data structure has a plurality of video object units, the video object unit being provided as a structure having said plurality of picture and voice information, and
said plurality of application information are provided to be inserted among said plurality of video object units, respectively.

3. A data structure according to claim 1, wherein said plurality of application information are provided to be inserted among the picture and voice information which are the predetermined units, respectively.

4. A data structure according to claim 1, wherein the application information are inserted among said plurality of picture and voice information as a capacity to an extent such that a read speed required by the application information and said plurality of picture and voice information does not exceed a read speed of a recording medium in which the data structure is to be stored.

5. A data structure according to claim 1, wherein said plurality of application information are allocated at positions which precede said plurality of picture voice information, whereby, when the information reproducing apparatus reads out the data structure, application information at a predetermined position corresponding to the picture information at a predetermined position can be read out precedently and expanded to a storage region.

6. A recording medium for storing in a recording region a data structure which configures picture information in accordance with a predetermined format and which is decoded and reproduced by an information reproducing apparatus, the data structure comprising:
a plurality of picture information on a predetermined unit by unit basis, the information being read and decoded by the information reproducing apparatus, and being reproduced to be a reproduction signal for displaying a picture together with a voice; and
a plurality of application information read and executed by the information reproducing apparatus, whereby predetermined images are reproduced to be a reproduction signal superimposed and displayed on the reproduced picture and the reproduced images are configured to be inserted among said plurality of picture and voice information on the predetermined unit by unit basis.

7. A recording medium according to claim 6, wherein the data structure has a plurality of video object units, the video object unit being provided as a structure having said plurality of picture and voice information, and
said plurality of application information are provided to be inserted among said plurality of video object units, respectively.

8. A recording medium according to claim 6, wherein said plurality of application information are recorded in the recording region so as to be inserted among the items of picture and voice information which are the predetermined units, respectively.

9. A recording medium according to claim 6, wherein the application information are recorded in the recording medium so as to be inserted among said plurality of picture and voice information as a capacity to an extent such that a read speed required by the application information and said plurality of picture and voice information does not exceed a read speed of the recording medium.

10. A recording medium according to claim 6, wherein said plurality of application information are allocated at positions which precede said plurality of picture voice information, whereby, when the information reproducing apparatus reads out the data structure, application information at a predetermined position corresponding to the picture information at a predetermined position can be read out precedently and expanded to a storage region.

11. An information reproducing apparatus comprising:
a readout section configured to read out a recording medium which stores in storage regions thereof said plurality of picture voice information on a predetermined unit by unit basis configured in accordance with a predetermined format and a plurality of application information inserted among said plurality of picture voice information, respectively;
a demultiplexer section configured to demultiplex said plurality of picture voice information read out by the readout section and the application information from each other;
a memory section configured to expand said plurality of picture and voice information demultiplexed by the demultiplexer section to a first storage region and to expand the application information to a second storage region;
a control section configured to make control so as to encode said plurality of picture and voice information expanded to the first storage region of the memory section, and to output a reproduction signal for displaying a picture together with a voice; and
a processing section configured to, in response to an instruction, output a reproduction signal for superimposing and displaying an image according to the application information expanded to the second storage region without intermitting a picture being reproduced by the control section.

12. An information reproducing apparatus according to claim 11, wherein the demultiplexer section carries out a demultiplexing process on the basis of the fact that a data structure of the recording medium has a plurality of video object units, the video object unit being recorded in the recording region as a structure having said plurality of picture and voice information, and that said plurality of application information are recorded in the recording region so as to be inserted among said plurality of video object units, respectively.

13. An information reproducing apparatus according to claim 11, wherein the demultiplexer section carries out a demultiplexing process on the basis of the fact that said plurality of application information are recorded in the recording region so as to be inserted among said plurality of picture and voice information, respectively.

14. An information reproducing apparatus according to claim 11, wherein the application information are recorded in the recording region so as to be inserted among said plurality of picture and voice information as a capacity to an extent such that a read speed required by the application information and said plurality of picture and voice information does not exceed a read speed of the recording medium.

15. An information reproducing apparatus according to claim 11, further comprising:
a multiplexer section configured to input picture information and voice information to be recorded; to further input application information to be executed to thereby generate picture and voice information in a predetermined unit; and to further divide the application information in plurality to thereby insert and multiplex said plurality of divided application information among said plurality of picture and voice information in the predetermined unit; and
a recording section configured to record the information multiplexed by the multiplexer section in the recording region of the recording medium.

16. A recording and reproducing method comprising:
reading out a recording medium which stores in storage regions thereof said plurality of picture voice information on a predetermined unit by unit basis configured in accordance with a predetermined format and a plurality of application information inserted among said plurality of picture voice information, respectively;
demultiplexing said plurality of picture voice information and the application information from each other;
expanding said plurality of picture and voice information demultiplexed by the demultiplexer section to a first storage region and expanding the application information to a second storage region;
decoding said plurality of picture and voice information expanded to the first storage region, and outputting a reproduction signal for displaying a picture together with a voice; and
in response to an instruction, outputting a reproduction signal for superimposing and displaying an image according to the application information expanded to the second storage region without intermitting a picture being reproduced.

17. A recording and reproducing method according to claim 16, wherein the demultiplexing process is carried out on the basis of the fact that a data structure of the recording medium has a plurality of video object units, the video object unit being recorded in the recording region as a structure having said plurality of picture and voice information, and that said plurality of application information are recorded in the recording region so as to be inserted among said plurality of video object units, respectively.

18. A recording and reproducing method according to claim 16, wherein the demultiplexing process is carried out on the basis of the fact that said plurality of application information are recorded in the recording region so as to be inserted among said plurality of picture and voice information, respectively.

19. A recording and reproducing method according to claim 16, wherein the application information are recorded in the recording region so as to be inserted among said plurality of picture and voice information as a capacity to an extent such that a read speed required by the application information and said plurality of picture and voice information does not exceed a read speed of the recording medium.

20. A recording and reproducing method according to claim 16, wherein picture information and voice information to be recorded are received, application information to be executed is further received to thereby generate picture and voice information in a predetermined unit, and the application information is further divided in plurality to thereby insert and multiplex said plurality of divided application information among the plurality of picture and voice information in the predetermined unit, and
the multiplexed information is recorded in the recording region of the recording medium.
